(19) United States
(12) Patent Application Publication
(10) Pub. No.: US 2005/0043857 A1
(43) Pub. Date: Feb. 24, 2005

(54) System for inventory control and capturing and analyzing consumer buying decisions

(76) Inventor: Steven Van Fleet, Lagrangeville, NY (US)

Correspondence Address: INTERNATIONAL PAPER COMPANY, 1422 LONG MEADOW ROAD, TUXEDO, NY, 10987, US

(21) Appl. No.: 09/891,544

(22) Filed: Jun. 23, 2001

Related U.S. Application Data
(60) Provisional application No. 60/213,762, filed on Jun. 23, 2000.

(51) Int. Cl. G05D 3/12

(52) U.S. Cl. 700/286

(57) ABSTRACT

An RFID tag contains a unique code The RFID tag in response to a query communicates identifying data, which is utilized to authenticate a product and provides information relating to consumer purchase decisions.

### CROSS REFERENCE TO RELATED APPLICATION

This application is based upon and claims the priority of U.S. Provisional Application Ser. No. 60/213,762, filed Jun. 23, 2000, the entire disclosure of which is incorporated herein by reference.

### BACKGROUND OF THE INVENTION

1. Field of the Invention

The present invention relates generally to the field of packaging, and specifically to a package interfacing to a computer system. The invention relates more particularly to inventory control and customer activity tracking systems for articles in a retail environment, and particularly to such systems which use RFID tags on articles or their packaging and the like.

2. Description of the Related Art

With the advent of improved product distribution systems and an increase in the overall cost of warehousing product inventory, the need has arisen to change the way in which businesses use and manage their inventory of products. Retail establishments face a significant task in maintaining and controlling large inventories of different products. To facilitate sales transactions, product exchanges and/or returns, inventory control, and theft control of articles in the establishment, many establishments place bar codes and/or sensitizable magnetic strips on the articles. The bar codes allow the articles to be quickly identified using a scanner. The magnetic strip is used in conjunction with a magnetic detection device at the store exit for theft control. The magnetic detection device triggers an alarm if a customer attempts to pass through a controlled exit carrying an article with a sensitized magnetic strip.

Magnetic strip-based systems have numerous disadvantages. Special equipment must be used to desensitize and resensitize the magnetic strips. Typically, store personnel must operate the equipment to ensure that check-in and checkout is performed accurately.

In addition, rapid manufacture and delivery systems have improved the ability of businesses to react to consumer demand. Obtaining the maximum benefit from these improved systems requires that buying trends of the consumer market be accurately monitored. The environmental factors relating to such consumer markets may include diversification of consumer values, a greater number of types of products, and shortened product life cycles. In light of these circumstances, the need exists for systems that gather consumer purchase information from consumer interaction with the sales agents and volume retailers who are in the forefront of marketing for comparison with information relating to the logistics of distribution and factory production plans.

Retail establishments currently review sales data to determine which articles are of the most interest to their customers. This information may be used to make decisions about new purchases or to better allocate existing resources. However, retail establishments fail to capture a large amount of information regarding customer preferences and product selection procedures since such information is not available from raw item sales data alone. In fact, movement of articles off of and back onto shelves by customers provides insights into their selection processes but data about such movements is presently not available. Thus, checkout counter (sales) data may fail to accurately measure which articles are of interest to certain customers.

Accordingly, there is a need for systems which allow retail employees to further reduce the time and effort spent in article handling, and which provide managers with better information about how their inventory is being handled and used. The present invention fills these and other needs as will appear hereinafter.

### SUMMARY OF THE INVENTION

The present invention utilizes a package identification and tracking system together with a “smart shelf” to gather information relating to consumer purchases and purchase decisions and uses the consumer information to resolve and improve upon decisions relating to packaging and pricing strategies, package location within a store, inventory control and development of consumer purchasing models. In its broad aspects, a system for carrying out the features of the present invention utilizes a computer system that maintains signal communication with packaged items while they are located on a store shelf. The removal and/or removal and replacement of packaged items on a shelf triggers an event record. A pattern recognition system within the computer collects and compares event records to known or learned product patterns. The comparison results in predictions as to purchase decisions.

In accordance with a further aspect, the present invention provides an inventory control and customer activity tracking system for use in conjunction with articles which are maintained in a retail display area. Each of the articles has an RFID tag attached to it. Each tag includes an antenna for use in detecting the presence of the article by receiving an interrogation signal and returning a response signal. The tag also includes an integrated circuit connected to the antenna for storing article identification information and for outputting the article identification information with the response signal upon interrogation of the tag. The system may comprise an article return area for receiving articles which were removed from the retail display area and which are to be returned to the display area, the returned article passing through a zone as the article is returned. An interrogator monitors the zone for disturbances in the form of a response signal caused by the presence of a tag within the zone, the interrogator outputting an interrogator output signal when a tag is detected in the zone, each interrogator output signal including unique identification information stored in the integrated circuit of the interrogated tag; and a database for receiving the interrogator output signals. The database includes inventory data for articles monitored by the system including checkout status data and the received interrogator output signals being used to update the checkout status data.

The present invention further comprises a retail inventory control system for use in conjunction with articles which are maintained in a retail display area. Each of the articles has a radio frequency tag attached to it. Each tag includes an antenna for use in detecting the presence of the article by receiving an interrogation signal and returning a response signal and an integrated circuit connected to the antenna for storing article identification information and for outputting the article identification information with the response signal upon interrogation of the tag. The system comprises an inventory database and a display interrogator. The database includes lists of articles currently and, optionally, recently in the retail establishment and the location and sales status of each of the articles. The display interrogator system scans the display area in discrete increments, detecting disturbances in the form of a response signal caused by the presence of tags within a predefined zone extending from each display interrogator. The display interrogator system also outputs an interrogator output signal when a tag is detected in an interrogator zone. Each interrogator output signal includes the unique identification information stored in the integrated circuit of an interrogated tag. The inventory database receives the identification information and uses the identification information to update the movement/location status of the articles displayed in the retail establishment.

In another embodiment, the present invention is a self-service checkout system for a retail establishment. The retail establishment has articles available for checkout by customers. Each of the articles has a radio frequency tag attached to it, and each tag includes an antenna for use in detecting the presence of the article by receiving an interrogation signal and returning a response signal. An integrated circuit is coupled to the antenna for storing unique article identification information and for outputting the article identification information with the response signal upon interrogation of the tag by an interrogator. The system comprises a checkout station for holding a plurality of articles; an interrogator for substantially simultaneously interrogating the plurality of articles placed on the station which the customer wishes to purchase, the interrogator receiving a response signal containing the stored article identification information for each of the plurality of articles to be purchased. The interrogator receives the response signals regardless of the orientation of the articles. An inventory database includes at least the articles in the retail establishment and the location status of each of the articles, the database receiving the article identification information for the article to be purchased; and a processor in communication with the database updates the location status of the articles to be purchased.

### BRIEF DESCRIPTION OF THE DRAWINGS

A more complete understanding of the present invention may be obtained from consideration of the following description in conjunction with the drawings in which:

FIG. 1 is a schematic block diagram of a retail establishment including displayed products and a product container support or shelf employing the present invention;

FIG. 2 is a flow diagram of an event record generator and a pattern recognition engine according to the present invention;

FIG. 3 is a block diagram of a product record according to the present invention; and

FIG. 4 is a diagram in schematic form of a geometric array of antennas in relation to a “smart shelf” according to the present invention.

### DETAILED DESCRIPTION

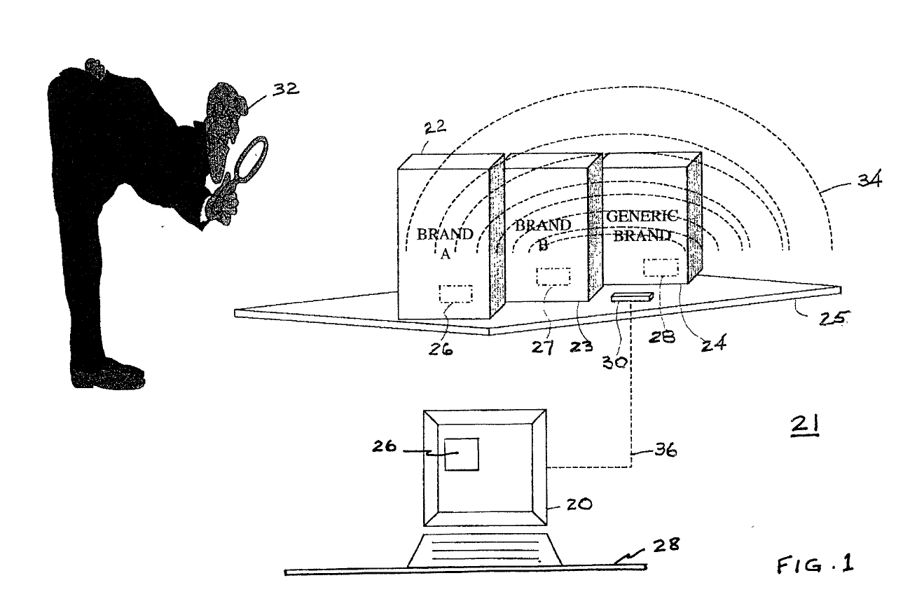

Referring to FIG. 1, a retail establishment 21 includes a product display area in the form of a plurality of shelves (a single shelf is shown) or stacks 25 for holding articles 22-24 such as various types of cosmetics, foodstuffs, toiletries, etc. A plurality of on-line computerized catalogs 26 of all articles which are available from the establishment may be provided by means of one or more data processing means such as computer terminals 20. One or more checkout counters 28, including point-of-sale (POS) computer terminals 20 are provided. Additional smart or dumb terminals may also be provided in the immediate vicinity of the product displays for facilitating customer interaction with the catalogs and other information. A database associated with the computer terminals 20 stores inventory data for all of the articles 22-24 in the inventory, as well as data regarding the articles 22-24 previously checked out (purchased) by customers. The on-line catalogs 26 may be connected to the computers 20 and the associated database. All or portions of the database may be maintained on-site at retail establishment 21 or at remote locations which are linked via a conventional data communications network to computers 20. Various allocations of computing capabilities may be made as between on-site and off-site (remote) locations. The retail establishment 21 further includes apparatus which is associated with novel methods and systems for inventory control and article movement tracking.

The present invention is embodied in its broadest aspects in a system comprising one or more computers 20 in signal communication with articles or product packages 22-24 located on “smart” store shelves 25. Advantageously, the packages 22-24 are each equipped with a transponder or “tag” 26-28 that communicates with the computer 20 through a compatible transceiver 30 located on, under or within the store shelves 25. A consumer 32 confronted with a purchase decision regarding like or similar products may remove and/or remove and replace one or more of the products 22-24 from a shelf 25 in order to inspect the product or its packaging during the purchase decision process.

The transponders 26-28 for each product package (article) include a unique identifier stored therein to identify the package, and, at any given time interval, a shelf sensing means or transceiver 30 may be directed to read the unique identifier from each package 22-24 contained on a shelf 25. A general type of transceiver 30 and transponder 26-28 combination suitable for this purpose may be found in commercially available Radio Frequency Identification (RFID) systems. An RFID system in the form of RF reading/writing equipment reads from or writes data to the transponders 26-28. Transponders 26-28 preferably are Radio Frequency (RF) tags that are present in a radio frequency field identified by reference numeral 34 projected from the transceiver 30. Data may be contained in, for example, or 64 or 128 or more digital bits for the purpose of providing identification and other information relevant to the object to which the tag 26-28 is attached. This system incorporates the use of electromagnetic or electrostatic coupling in the radio frequency portion of the spectrum to communicate to or from a tag through a variety of modulation and encoding schemes. Suitable RFID components are described, for example, in International Patent Application Serial No. PCT/US01/08669 which is commonly owned with the present application, as well as in commonly owned U.S. application Ser. No. 09/817,761. The disclosures of such commonly owned applications are herein incorporated by reference.

In the presently described embodiment, the radio frequency field 34 is limited to the space above the shelf 25. The computer 20, when in signal communication 36 with the transceiver 30, is able to read a unique product identifier for each package having a transponder 26-28 within the radio frequency field 34 of the shelf 25. When a product 22-24 is removed from the shelf 25, it is taken out of the radio frequency field 34 of the transceiver 30. The computer 20 is adapted (programmed) to detect a change in the status or location or number of product identifiers detected in relation to each shelf configured in the manner of shelf 25.

Details of the transponders 26-28 and transceiver 30 may vary according to each application. In a preferred embodiment, each transponder 26-28 on the packages 22-24 has sufficient processor and memory capacity to allow each package 22-24 to have a unique identifier and the ability for each transponder 26-28 to communicate with a shelf transceiver 30. Each of the transceivers 30 associated with the shelf 25 is fabricated in such a manner that it will allow a reader circuit to sense the presence or absence of any package 22-24 having an associated transponder 26-28 (e.g. on its surface). The shelf transceiver signal communication 36 with the computer 20 can include hardwire or wireless connections.

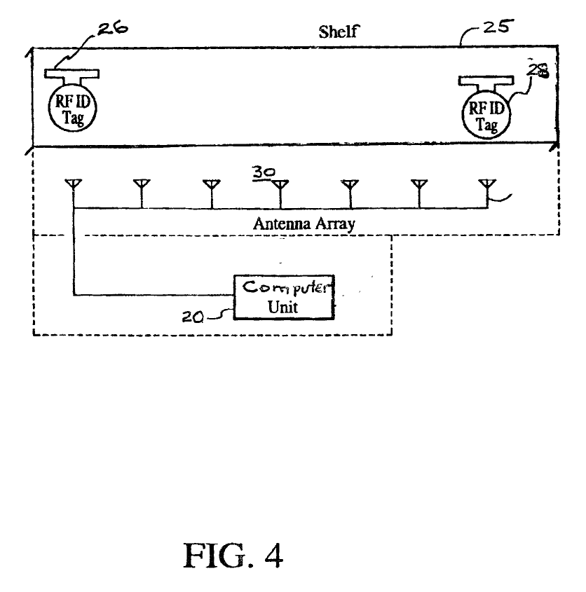

In a preferred practical arrangement, a plurality of transceivers 30 are associated with each shelf (see FIG. 4) and are arranged in a geometric (e.g. parallel) array according to the intended arrangement of articles 22-24 on shelf 25. For example, in the case where cosmetic or nail polish containers are the intended articles for display, the items are typically arranged in well-defined rows and columns on shelf 25. In that case, a plurality of transceivers 30, each having, for example, an elongated oval antenna (wire) aligned in the direction of and with one or more of the product columns, is provided. Such a system is capable, when energized, of defining the physical location of each article and its unique identity each time the transceiver is energized (pulsed).

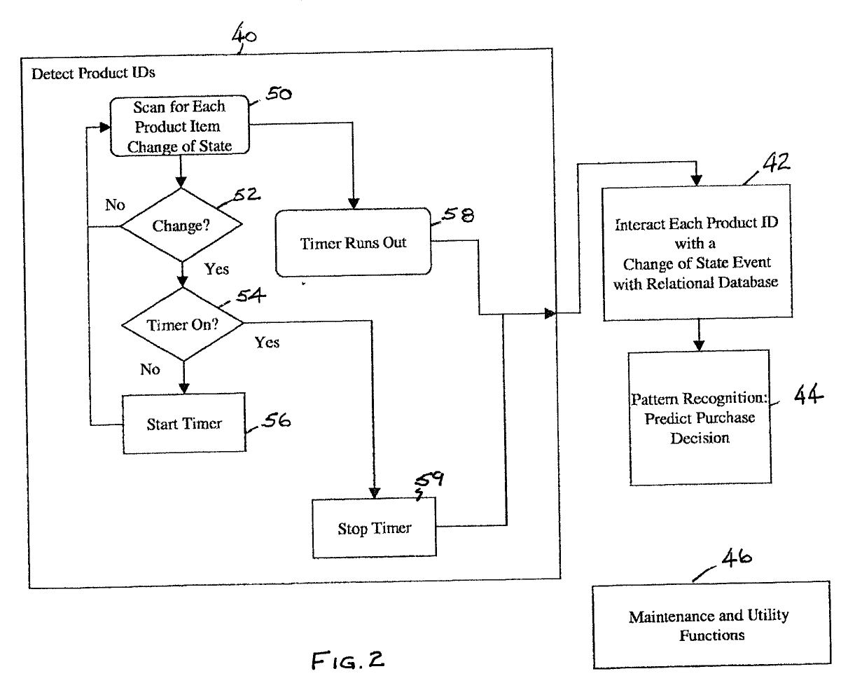

With reference to FIG. 2, the computer 20 utilizes software that executes, for example, four functional components or routines. When a product article 22-24 is removed from or replaced on a shelf 25, the computer 20 detects and records the occurrence of the event by means of a change of state routine or program (engine) 40 as will be explained below. Events that occur with respect to like or related products may be associated through a relational database by a Database Interaction routine or program (engine) 42. A prediction program 44 uses the related data for a comparison to a set of consumer purchase patterns resulting in a consumer prediction that is established for related events that occur in a relatively short period of time. Maintenance and utility functions 46 are handled separately.

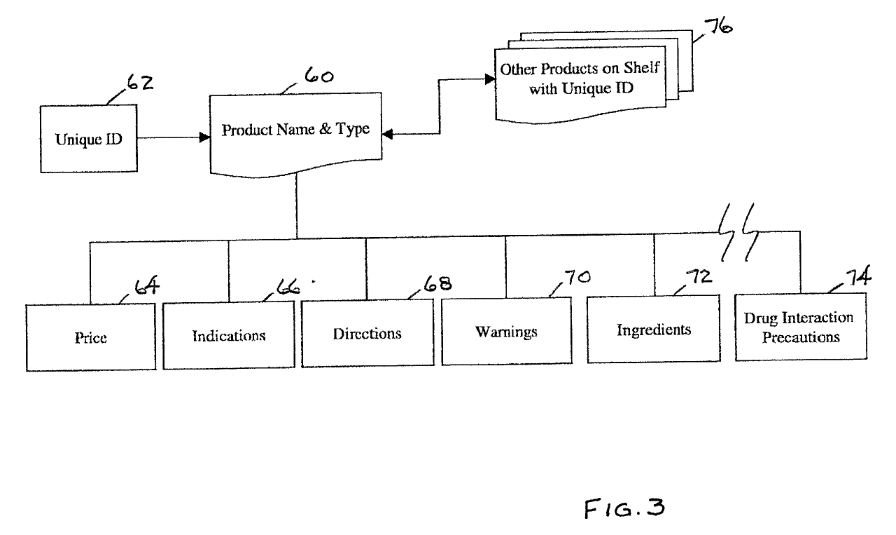

With continued reference to FIG. 2, the change of state engine 40 preferably detects when a product 22-24 is removed from or removed from and replaced on a shelf 25. Periodically, the computer 20 will request that the transceiver(s) 30 (FIG. 1) be energized so as to read, in sequence, the unique identifiers for each of the transponders 26-28 located on the shelf 25 at step 50 (FIG. 3). For each unique ID, the computer determines whether the corresponding article 22-24 has been removed or replaced as indicated by a “change of state”. If a change of state occurred in the particular data, the computer 20 checks for a timer at step 52 to establish a time line. Otherwise, the computer 20 continues checking other unique IDs at step 50. If the timer is off, the computer 20 starts a timer at step 54 and returns to check other unique IDs at step 50. Otherwise, if the timer is on, the computer stops the timer at step 56. The unique ID and timer-stop time are transmitted to the Database Interaction Engine 42. The timer may include a predetermined limit that triggers an interrupt at step 58. When the interrupt limit is reached the timer is stopped and the unique ID and timer stop time are transmitted to the Database Interaction Engine 42. This sequence may be repeated at relatively short intervals (e.g. multiple times per second) in order to sense relatively short removal times on the part of customers.

With reference to FIG. 3, the Database Interaction Engine 42 is arranged to associate (locate) product name data 60 with the unique ID 62 of a particular article. The product name data 60 can include, but is not limited to, data fields such as price 64, “indications” (reactions) 66, directions 68, warnings 70, ingredients 72 and drug interaction precautions 74. Other data 76 for products similar to the unique IDs may be located as well.

The prediction engine 44 (FIG. 2) preferably uses a pattern recognition algorithm such as a neural network that will interpret the physical actions of the consumer and predict the reason for a particular purchase or non-purchase. However, those skilled in the art will appreciate that even a simple look up table may be used to accomplish a rudimentary result. Typical patterns identified may include, but are not limited to:

A review of a product by a consumer, but there was no purchase.
A review of a brand name and a generic product with the consumer
purchasing the generic product.
A purchase made based upon price.
A purchase decision based upon a comparison of an ingredient, dosage,
warnings, etc.
A restocking pattern.
A slow moving shelf inventory pattern.
A prediction of optimum shelf and configuration.
Brand Loyalty.
When consumer is carrying a smart card compatible with the transceiver of
the shelf, considering product selection as a function of demographics such
as race, income level, sex, etc.
When multiple stores are included in the application, predicting an
optimum shelf and product distribution as a function of location.
Product movement as a function of shelf location in relation to consumers.

In a preferred embodiment, the computer 20 has a change of state engine 40 and prediction engine 44 that will interpret the actions of the consumer and predict the reason for a purchase and interpret non-consumer actions, such as restocking or redistribution. It will be appreciated that the data when collected over time may allow for data retrieval of consumer buying trends during any period of time requested by the end user. The computer 20 can be adapted to communicate with multiple shelves 25 using this configuration. Furthermore, the computer 20 may be adapted to communicate with multiple stores 21 and multiple sites to coordinate aggregate consumer buying trends.

It will be appreciated that variations of the hardware and software may occur to carryout the acquisition of and knowledge extraction of the data. The data could be stored on the package as a barcode, a radio frequency identification tag, a contact memory chip, an optical memory card or a magnetic chip.

It will be further appreciated that most retail stores gather data describing consumer purchasing trends generally made available from Point of Sale (POS) data. POS data is generally known to have certain drawbacks. POS data does not account for inventory shrinkage (theft) nor does it describe the product location at the time of a consumer selection such as in the back room or on a store shelf. The data collection techniques of the present invention overcome these problems with conventional POS data collection techniques.

### EXAMPLE

In a typical transaction, a consumer 32 (FIG. 1) removes one package of brand A 22 from the shelf 25. The transceiver 30 on the shelf 25 registers that the package 22 has been removed. The shelf transceiver 30 transmits the change of state with the unique identifier of the package 22 to the computer 20. The computer 20 will register the unique identifier and relates it to brand A. The computer starts a timer.

The consumer 32 removes one package 23 of brand B from the shelf 25. The transceiver 30 on the shelf 25 registers removal of the package 23. The transceiver 30 transmits the change of state with the unique identifier of the package 23 to the computer 20. The computer 20 will register the unique product identifier and relates it to brand B. A second timer is started.

The consumer 32 then returns the package 22 of brand A to the shelf 25. The shelf transceiver 30 registers the return of brand A 22 to the shelf 25. The timer associated with brand A stops. The consumer 32 leaves with the package 23 of brand B which results in the second timer associated with brand B exceeding a predetermined limit. The information for brand A and brand B are retrieved by the database interaction engine 42. The data reveals that the ingredients, dosage, warnings, etc. are similar, but the price of brand B is less then brand A.

The prediction engine 44 predicts a purchase was made based upon brand loyalty and price.

In view of the foregoing description, numerous modifications and alternative embodiments of the invention will be apparent to those skilled in the art. Accordingly, this description is to be construed as illustrative only and is for the purpose of teaching those skilled in the art the best mode of carrying out the invention. Details of the structure may be varied without departing from the scope of the invention which is set forth in the appended claims.

1. A package identification and tracking system for use in analyzing consumer buying decisions comprising:
a plurality of products, each having a tag with a unique code;
a tag reader having a tag detection range; and
change of state detection means for determining when each said product enters or leaves said tag detection range.

2. The package identification and tracking system of claim 1 comprising:
prediction means adapted for predicting a consumer purchase decision.

3. A package identification and tracking system according to claim 1 wherein:
said tag reader comprises a geometric array of reading devices having individual tag detection ranges; and
each said product is associated with a particular one of said reading devices.

4. A package identification and tracking system according to claim 3 wherein:
said tag readers and said products are associated with a product display; and
said tag readers comprise interrogators for identifying the unique code and physical location of each said product with respect to said product display.

5. A package identification and tracking system according to claim 4 and further comprising:
data storage means for compiling an inventory database including at least identification of all articles in the product display and the location status of each of the articles, the database receiving, from said tag readers, the initial location information and the article identification information for each of the articles on display; and
a processor in communication with the data storage means for updating the location status of the articles on display.

6. The package identification and tracking system according to claim 5 wherein each said tag is an RFID tag.

7. The package identification and tracking system according to claim 2 wherein:
said tag reader comprises a geometric array of reading devices having individual tag detection ranges; and
each said product is associated with a particular one of said reading devices.

8. The package identification and tracking system according to claim 7 wherein:
said tag readers and said products are associated with a product display; and
said tag readers comprise interrogators for identifying the unique code and physical location of each said product with respect to said product display.

9. The package identification and tracking system according to claim 8 and further comprising:
data storage means for compiling an inventory database including at least identification of all articles in the product display and the location status of each of the articles, the database receiving, from said tag readers, the initial location information and the article identification information for each of the articles on display; and
a processor in communication with the data storage means for updating the location status of the articles on display.

10. The package identification and tracking system according to claim 9 wherein each said tag is an RFID tag.

11. A package identification and tracking system for a retail outlet having articles available for selection and removal by customers, each of said articles having a radio frequency tag attached, each tag comprising an antenna for indicating the presence and identification of the associated article upon receiving an interrogation signal and returning a response signal, and an integrated circuit coupled to said antenna for storing at least article identification information and for supplying said article identification information with the response signal upon interrogation of said tag by an interrogator, the system comprising:
a plurality of interrogator antennas arranged in a geometric array located in a product display area of the retail facility for interrogating each said article to determine at least its location and identity for each said article, the interrogator receiving a response signal containing the stored article identification information for each of the articles to be offered to customers, wherein the interrogator may substantially simultaneously receive response signals from a plurality of tagged articles;
data storage means for compiling an inventory database including at least identification of all articles in the product display and the location status of each of the articles, the database receiving the initial location information and the article identification information for each of the articles on display; and
a processor in communication with the data storage means for updating the location status of the articles on display.

12. The system according to claim 11 wherein the tag is an RFID tag.

13. An inventory control system for use in conjunction with articles which are displayed in a retail establishment in accordance with claim 11, each of said articles having a radio frequency tag attached, each tag comprising an antenna for use in detecting the location and identity of said article by receiving an interrogation signal and returning a response signal and an integrated circuit coupled to said antenna for storing at least article identification information and for supplying said article identification information with the response signal upon interrogation of said tag by an interrogator, the system comprising:
data storage means for storing an inventory database comprising at least identification of the articles on display in said retail establishment and the location status of each such article;
an article checkout system located in an article checkout area of the retail establishment, the checkout system comprising a first interrogator for interrogating an article that a customer has selected to remove from the retail establishment, the first interrogator receiving a response signal containing the stored article identification information for the article to be removed; and
a processor in communication with the first interrogator and the database, the processor receiving article identification information for the article to be removed from the first interrogator, and updating the inventory database with the location status of the article to be removed.

14. An inventory control system according to claim 13 and further comprising:
an article return facility for receiving articles which were removed from the retail establishment, each returned article passing through a check-in zone as the article is returned;
a second interrogator in communication with the inventory database, the second interrogator monitoring the check-in zone for a response signal caused by the presence of a tag within the zone, and outputting an interrogator output signal when a tag is detected in the zone, each interrogator output signal including the identification information stored in the integrated circuit of an interrogated tag for the article being returned, wherein the inventory database receives the interrogator output signal and updates the status of the article being returned using the interrogator output signals.

15. An inventory control system according to claim 14 and further comprising
an exit interrogator for monitoring an exit from the retail establishment so as to interrogate each article passing through the exit and being removed from the retail establishment, the exit interrogator receiving a response signal from the tag associated with each article, the response signal containing the stored article identification information for the article passing through the exit; and
an exit processor coupled to the exit interrogator, the exit processor receiving an output signal from the exit interrogator including the identification information of the response signal, wherein the exit processor compares the received identification information whit the information stored in the database to determine whether the article is recorded therein as checked out, wherein the exit interrogator activates an alarm if the article passing through the exit is not recorded in the database as checked out.

16. An inventory control system for use in conjunction whit retail articles which are maintained in a retail storage area in accordance with claim 11, each of the articles having a radio frequency tag attached, each tag including an antenna for use in detecting the presence of the article by receiving an interrogation signal and returning a response signal and an integrated circuit connected to the antenna for storing article identification information and for outputting the article identification information with the response signal upon interrogation of the tag, the system comprising:
at least one article return area for receiving articles which were removed from the storage area and which are to be returned to the storage area, the article return area including an interrogation zone and a collection zone for holding returned articles, the returned articles passing through the interrogation zone and into the collection zone as the articles are returned, wherein plural articles may simultaneously placed in the collection zone;
an interrogator for monitoring the collection zone for disturbances in the form of a response signal caused by the presence of one or more tags within the collection zone, the interrogator sequentially interrogating each retail article in the collection zone, the interrogator outputting an interrogator output signal for each tag detected in the collection zone, each interrogator output signal including the identification information stored in the integrated circuit of an interrogated tag; said interrogator being coupled to a database for receiving the interrogator output signals, the database including inventory data for retail articles monitored by the system including checkout status data, the received interrogator output signals being used to update the checkout status data of each returned retail article.

17. The system according to claim 16 wherein the inventory data includes article removal date data.

18. The system according to claim 17 wherein each said tag is an RFID tag.

19. A product display and information system comprising:
a plural of product container supports for storing a quantity of product containers for display to customers;
identifier means for providing a unique identifier for each said product container;
sensing means associated with each of said product container supports for sensing and identifying individual ones of said containers;
data processing means for tracking individual ones of said containers with respect to said supports so as to generate product container movement data;
a communications network for transmitting signals comprising said unique identifiers and at least said movement data; and
a data processor coupled to said communications network for recovering said transmitted signals to determine one or more parameters selected from a group comprising inventory, sales, unauthorized removal, replacement, customer product selection activity and time of occurrence of any of the foregoing.

20. A product display and information system according to claim 19 wherein:
said sensing means further comprises antennae each associated with a respective group of said product containers.

21. A product display and information system according to claim 20 wherein:
said product container supports comprise product shelves, each of said shelves supports a plurality of product containers and each of said antennae is associated with one of said shelves and with a plurality of said product containers.

22. A product display and information system according to claim 21 wherein:
each of said antennae is associated with a group of said containers arranged in a geometric pattern on a respective one of said shelves in close proximity to one of said antennae.

23. A product display and information system according to claim 20 wherein:
said data processing means comprises a memory for storing each said unique identifier for each product container and a corresponding location for each said product container; and
said sensing means detects any absence of a previously identified product container.

24. A product display and information system according to claim 19 wherein:
said identifier means comprises an electronic radio frequency identification device.

25. A product display and information system according to claim 22 wherein:
said identifier means comprises an electronic radio frequency identification device.
